(19) United States
(12) Patent Application Publication
(10) Pub. No.: US 2009/0142657 A1
(43) Pub. Date: Jun. 4, 2009

(54) Battery Separator

(76) Inventor: William Winchin Yen, Acton, MA (US)

Correspondence Address: Howard Troffkin, 7808 Ivymount Terrace, Potomac, MD, 20854, US

(21) Appl. No.: 11/988,218

(22) PCT Filed: Jul. 6, 2006
(86) PCT No.: PCT/US2006/026474

§ 371 Date: Jan. 3, 2008

Related U.S. Application Data
(60) Provisional application No. 60/697,952, filed on Jul. 12, 2005.

(51) Int. Cl. H01M 2/16

(52) U.S. Cl. 429/145

(57) ABSTRACT

The present invention is directed to a sheet product useful as a battery separator. The sheet product is composed of a microporous polymeric sheet product having at least one ply, wherein at least one ply comprises a microporous sheet formed from a polymeric composition of a first polymer having low glass transition temperature and having a second ply coating a major portion of the pore and external surfaces of the first polymer microporous sheet. The first polymer is selected from a thermoplastic polymer that has a glass transition temperature of less than −50° C. and a melt temperature of at least 70° C. The second polymer coating a major portion of the microporous sheet of first polymer is selected from (a) a thermoplastic polymer having a glass transition temperature which is at least 60° C. above that of the first polymer or (b) a thermoset polymer having a degradation temperature that is at least 40° C. higher than the melt temperature of the first polymer The present battery separator exhibits a high degree of dimensional stability while causing shut-down of the battery's electrochemical reaction under elevated temperature conditions.

### BACKGROUND OF THE INVENTION

The subject invention is directed to sheet products useful as improved battery separators and especially useful in lithium battery systems. The present battery separators exhibit dimensional stability under elevated temperature conditions as may occur within battery environs and, thereby, prevent contact between electrodes of opposite polarity.

Storage batteries have at least one pair of electrodes of opposite polarity and, generally, have a series of adjacent electrodes of alternating polarity. The current flow between these electrodes is maintained by an electrolyte, which can be acid, alkaline or substantially neutral depending on the nature of the battery system. Separators are located in the batteries between adjacent electrodes of opposite polarity to prevent direct contact between the oppositely charged electrode plates while freely permitting electrolytic conduction. The separator is normally in the form of a thin sheet or film or, in certain designs, can be in the form of an envelope surrounding each electrode plate of one polarity. It is generally agreed that separators should be (a) thin and light weight to aid in providing a single cell or a battery having a plurality of cells of high energy density, (b) resistant to degradation and instability with respect to the battery components with which it is in contact, (c) capable of exhibiting a high degree of electrolytic conductivity (low electrolytic resistance) and (d) in appropriate battery systems, capable of inhibiting formation and growth of dendrites.

Separators conventionally used in present battery systems are formed of polymeric films which when placed in an electrolyte or electrolytic system, are capable of exhibiting a high degree of conductivity. The films may be macro-porous or micro-porous to thus permit transportation of electrolyte. Microporous separators are preferred as they aid in inhibiting dendrite growth as well as the contact of adjacent electrodes of opposite polarity. Examples of such separators include polyethylene or polypropylene sheets that have been stretched and annealed to provide microporosity in the sheet. However, such sheets, as disclosed in U.S. Pat. Nos. 3,426,754; 3,558,764; 3,679,538; 3,801,404 and 4,994,335, are normally highly oriented and shrink when subjected to heat. Some separators are formed from thicker, filled polymeric sheets, such as those disclosed in U.S. Pat. Nos. 3,351,495 and 4,287,276, in which the electrolyte is capable of passing through the separator's microporous channels and by the wicking of the filler. These separators are normally limited in their application due to incompatibility of the filler with other battery components.

U.S. Pat. Nos. 4,650,730 and 5,281,491 describe battery separators designed to be capable of reducing its porosity at a predetermined elevated temperature. The separator is theoretically capable, upon detection of overheating, of becoming a barrier to the passage of ions between electrodes of opposite polarity. These separators are composed of sheet products having at least two distinct microporous plies with one ply being formed of a low melting polyolefin (e.g. polyethylene) capable of transforming to a non-porous sheet at a predetermined temperature. The second ply is of a higher melting point polyolefin (e.g. polypropylene) to impart stability to the multiply sheet product. However, it has been observed through standardized tests (UL abusive cell tests) that, because thermal run away, once started, normally occurs very rapidly, the ply that becomes non-porous at the predetermined elevated temperature tends to cause identical shrinkage (or pull) of the total multi-ply separator product. This allows the electrodes to come in contact and results in degradation of the cell by fire or explosion.

U.S. Pat. No. 6,296,969 to Yano et al. describes a battery separator composed of a ceramic fibrous non-woven mat that is impregnated with a microporous polyolefin material. This separator has the defect of being relatively thick which detracts from the energy density of the battery design. Further, the non-woven sheet contains relatively large openings (e.g. of about 100 microns) which can not ensure electrode separation.

U.S. Pat. No. 5,741,608 to Kojima et al. discloses a battery separator comprising a plurality of sheets, such as at least one polyimide or glass sheet with at least one microporous polyolefin sheet. Again, like Yano et al., this battery separator is a multi-ply configuration that reduces the energy density of the resultant battery design.

It is highly desired to have a single microporous sheet product for battery separator applications that can exhibit high degree of dimensional stability at elevated temperatures. Such separators would inhibit shrinkage as the temperature of the system increases and prevent exposure and contact of electrodes of opposite polarity, which can cause a thermal run away battery that may catch fire and/or explode, especially when used in modern battery systems, such as lithium battery design.

The sheet product of the present invention provides a battery separator having improved dimensional stability when cell temperatures rise and thereby prevents the battery electrodes of opposite polarity from touching. Further, the battery separator of the present invention provides improved safety performance of the battery, especially when used in rechargeable battery systems, such as formed from lithium cell(s).

The sheet product of the present invention provides a battery separator that can exhibit substantially no shrinkage and, thereby, prevents contact between electrodes of opposite polarity. The formed separator is also capable of causing high resistance to electrochemical flow to substantially shut down the battery function at temperatures above normal operating temperatures.

The sheet product of the present invention is especially useful as a battery separator in a rechargeable battery cell in which the ion source is lithium metal, a lithium compound, or a material capable of intercalating of lithium ions.

The sheet product of the present invention provides a battery separator that can be formed of a single ply to achieve a high energy density battery system, without the concern of enabling a closed circuit to form between adjacent electrodes of opposite polarity.

The sheet product of the present invention provides a battery separator that can cause the termination of ion transfer between electrodes of opposite polarity while remaining dimensionally stable.

### SUMMARY OF THE INVENTION

The present invention is directed to a sheet product useful as a battery separator, especially applicable to lithium battery designs, that is composed of a microporous polymeric sheet product formed of a polymer of low glass transition temperature (Tg) and having substantially throughout the exterior and pore surfaces of the microporous sheet, a film of a polymer of high glass transition temperature. The battery separator is capable of exhibiting dimensional stability while causing a shutdown of the battery's electrochemical reaction under severe elevated temperature conditions encountered at abusive conditions.

### BRIEF DESCRIPTION OF DRAWINGS

FIG. 1 shows charge and temperature data of a battery cell, having a coated polyethylene microporous sheet product according to the present invention as its battery separator, under low rate charge while being subjected to elevation in temperature over time. The battery cell exhibited voltage stability at elevated temperatures (up to 160° C.) of the test.

FIG. 2, for comparative purposes, shows charge and temperature data of a battery cell, having a commercial polyethylene microporous sheet product as its battery separator, under low rate charge while being subjected to elevation in temperature over time. The cell exhibited catastrophic failure at about 135° C.

### DETAILED DESCRIPTION OF THE INVENTION

The present invention provides an effective and efficient microporous sheet product composed of a first polymer of low glass transition temperature and melt temperature which has contained on its exterior and pore surfaces a second polymer of high glass transition temperature and melt temperature or of a thermoset resin.

For purposes of clarity, some of the terms used herein and in the appended claims to describe the instant invention are defined below:

A “sheet” is intended to define a structure having large length and breadth dimensions with respect to its thickness and the thickness is less than about 10 mils preferably less than about 5 mils and most preferably less than about 3 mils.

A “sheet product” comprises a microporous sheet composed of a polymeric composition composed of a first polymer having a low glass transition temperature (Tg) of less than about −5° C. and a melt temperature (Tm) of at least 70° C. and having on its exterior and pore surfaces a coating of a polymeric composition of a second polymer selected from a thermoplastic polymer having a glass transition temperature (Tg) of at least about 60° C. higher than that of the first polymer forming the microporous sheet or a thermoset polymer having a degradation temperature that is at least 40° C. above the melt temperature of the first polymer forming the microporous sheet. The second polymer forms a coating on the surfaces of the first polymer sheet to be interdispersed with the first polymer providing a skeleton support structure to the overall microporous sheet product.

The term “coating” and “film” when used herein, is intended to refer to a second polymeric composition in the form of a covering over a major area of the exterior and pore surfaces of the microporous sheet of the sheet product.

The term “microporous”, when used herein is intended to mean pores of the sheet product that is of an average pore diameter of from 0.001 to 5 microns, preferably from 0.01 to 1 micron. The pores may be of any configuration and are, preferably, of a tortuous configuration when taken from one major surface to the other major surface of the sheet product.

The term “first”, when used herein is intended to modify terms to reference them to the polymeric composition forming the initial microporous sheet of the sheet product.

The term “second”, when used herein is intended to modify terms to reference them to the polymer contained on the pore and exterior surfaces of the sheet product.

The term “polymeric composition” refers to a thermoplastic polymer which may contain, substantially uniformly distributed therein, other materials such as, plasticizers, antioxidants, dyes, colorants, extractable material (a liquid that is extractable, at least at elevated temperature) and the like. The polymeric compositions found useful in the present invention may be substantially unfilled or may be partially filled (e.g. up to about 60 volume percent) with solid particulate fillers.

The term “fluidity” is intended to refer to the ability of a polymer composition to flow, that is, to have polymer molecules of the composition capable of sliding over one another. This property is exhibited by thermoplastic polymers at temperature above their glass transition temperatures. The ability will depend upon the polymer's particular configuration, i.e. linear or branched, crystalline or amorphous, degree of cross-link and the like. The fluidity can be measured by conventional techniques such as using Standard Load Melt Index tests (ASTM D-1238-57T) modified to be measured at varying temperatures.

A “separator” is a component of a battery, in particular a storage battery, by which the component maintains a separation between adjacent electrode plates of opposite polarity. A separator of the present invention is formed from sheet product and may be in various configurations such as, flat, ribbed, corrugated membrane or an envelope capable of maintaining separation between electrodes of opposite polarity.

The polymeric compositions useful in forming sheet product of the present invention are composed of known polymers, copolymers and mixtures of polymers and copolymers capable of forming a microporous sheets (herein after “first polymer”) as, for example, polyolefins, polyvinyl halides, such as polyvinyl chloride, polyvinyl fluoride, polyvinylidene dichloride, polyvinylidene difluoride, mixtures thereof and the like. Copolymers can be formed from these monomers with other monomeric compounds having ethylenic unsaturation. The preferred first polymers are polyolefins. The first polymer should have a low glass transition temperature (T_{g}) of lower than about −5° C., preferably lower than −10° C. and most preferably below −20° C. while having a melt temperature (Tₘ) of at least 70° C., preferably at least 90° C. and more preferably of at least 110° C.

A preferred class of first polymers is polyolefins due to their inertness with respect to the other battery components with which they come in contact. The remainder of this description shall illustrate the present invention by combinations of the preferred embodiment wherein polyolefins of low T_{g} are used to form microporous sheet material and separators therefrom. For example, first polymers can be selected from polyolefin wax, low density polyethylene, low molecular weight, high density polyethylene, polypropylene, ethylene-butene copolymers, ethylene-hexene copolymers, ethylene/methacrylate copolymers and the like and mixtures thereof and copolymers of ethylene or propylene with other alpha-olefins (especially C₄ to C₁₀ alpha-olefins). Such alpha-olefins are normally present in from 5 to 20 weight percent of the copolymer. The polyolefins should have a weight average molecular weight of from 100,000 to about 5,000,000. Preferably, the first polymer will have a weight average molecular weight of from about 100,000 to about 1,000,000.

Microporous sheets of first polymer can be formed by conventional techniques known to those skilled in the art. For example, such sheets are conventionally formed by initially forming a non-porous sheet (by extrusion or other conventional techniques) having a filler and/or a low temperature material (e.g. hydrocarbon oil) in the non-porous sheet composition. The initial sheet is a polymeric network with the filler and/or low temperature material (e.g. oil) encapsulated therein. The filler and/or low temperature material is then extracted to provide the resultant microporous sheet suitable for use in forming the sheet product of the present invention. Alternately, microporous sheets are formed by subjecting a non-porous sheet to at least one series of stretching (e.g. in the axial or transverse direction or both the axial and transverse directions) and annealing to achieve microporosity in the resultant sheet.

With respect to thermoplastic polymers, it is well known that such materials do not exhibit classical solid to liquid phases. They can be viewed as “viscoelastic” materials. Although they exhibit a liquid state above the melt temperature and a solid state below the melt temperature, it is observed that, within the solid state, the polymers exhibit a second-order transition from a glassy, rigid state to a flexible, rubbery state. This rather sharp change is named the glass transition, and the temperature at which this transition occurs is conventionally referred to as the glass transition temperature (T_{g}). The polymer chains below the glass transition temperature are generally tightly packed with very little mobility. Above the glass transition temperature, the polymer chains exhibit some degree of fluidity and slip passed one another. Thus, at temperatures above a polymers glass transition, the materials formed therefrom have poor dimensional stability and exhibit shrinkage or “creep”.

Polyethylene and polypropylene are conventionally selected for battery applications because of their ease in fabrication and chemical inertness to maximize degradation stability. However, these materials have very low glass transition temperature and, therefore, exhibit poor dimensional stability at operational temperatures of a battery. The operational temperatures normally range from ambient temperatures up to about 70° C. For example, typical operational temperatures of a battery packaged within electronic devices can reach up to about 70° C. At operational temperatures, polyolefin separators tend to creep. Either due to the separator creep which eventually allows contact between electrodes or the battery's subjection to abusive conditions, the temperature of at least a portion of the system will dramatically elevate and the polyolefin separator will drastically shrink to result in fire and/or explosion of the battery system.

Examples of suitable first polymers are:

| | Tg (C.) | Tm (C.) |
|---|---|---|
| Polyethylene | −120 | 137 |
| Polypropylene | −10 | 176 |
| Polyvinyl fluoride | −20 | |
| Polyvinylidene fluoride | −25 | 175 |

The sheet formed of the first polymer may further have a fibrous woven or non-woven mat adhered to one of its exterior surfaces or alternately embedded within the formed sheet. The mat may be formed from any fibrous material such as, for example, glass fibers (preferred), polyesters, polyimides, ceramic, polyamides (e.g. Nylon) or cellulose or the like. The mat can be made part of the first polymer sheet as part of the process of forming the sheet (such as having the mat coextruded with the initial first polymer composition). Alternately, the mat can be contacted with the first polymer sheet (either in its non-porous or its porous state) by passing a fibrous mat and at least one first polymer sheet through a set of nip rollers preferably while the sheet is at an elevated temperature (such as directly after formation by extrusion). It is preferred that the mat, when employed, is made part of the sheet of first polymer prior to imparting porosity to the formed first sheet. It has been found that when one treats a first sheet of microporous polyolefin with a second polymer selected from a thermoplastic polymer having high glass transition temperature or a thermoset polymer, one obtains a sheet product having good dimensional stability over the full normal operating temperature range. Further, the resultant separator product is capable of forming a substantially non-porous sheet at the melt temperature of the first polymer without sacrificing the dimensional properties of the sheet product. Thus, if the battery is subjected to abusive conditions, such as improper application of the battery, the battery will shut down without harmful effect and without further amplification of the thermal run away of the system by electrode contact.

The sheet product of the present invention provides an improved battery separator that does not exhibit substantial creep and shrinkage exhibited by conventional prior art battery separator materials. It has been unexpectedly found that when microporous polyolefin sheets, such as conventionally used, are further treated to form the sheet products of the present invention, a high degree of dimensional stability is achieved. Further, the present sheet products provide a means of terminating the ion transfer of the battery under potential thermal run away temperature conditions and, thus, cause the battery device to shut down without the potential deleterious effects of fire and/or explosion.

The improved product of the present invention is a conventional microporous sheet formed of a first polymer, as described herein above, that has a high glass transition temperature second polymer substantially uniformly contained on the exterior and internal pore surfaces of the microporous polyolefin sheet's network. The second polymer is selected from thermoplastic polymers having a glass transition that occurs at a temperature of at least about 60° C., preferably at least about 80° C., and most preferably at least about 110° C. above the T_{g} of the first polymer used to form the microporous sheet. In addition, the second polymer should have a melting temperature (Tₘ) that is higher than the Tₘ of the first polymer. Each of the polymers exhibits a distinct polymer network, which when viewed together, are interdispersed with respect to the other.

The second polymer can be applied to the surfaces of the first polymer by any conventional technique, such as incipient wetness impregnation techniques, to deposit second polymer on the surfaces of the first polymer sheet. For example, the second polymer can be formed into a solution using a liquid in which the second polymer is soluble and the first polymer is not soluble. The second polymer should be in a concentration of from about 1 to 30, preferably from about 1 to 20, and most preferably from about 2 to 15 weight percent of the solution. For example, the liquid may be selected from chlorinated hydrocarbons (Cl.H.), aromatics, ketones, alcohols or pyrrolidine solvents, such as methylene chloride, toluene, acetone and isopropanol and 1-methyl-2-pyrrolidinone and the like. The concentration of second polymer used in forming the solution will depend on the porosity of the first polymer sheet, the degree of coating desired, the solvation of the solvent used with respect to the second polymer, and the like. The appropriate solution to form the desired coating of second polymer on a first polymer sheet can be determined by minor experimentation.

The initially formed microporous first polymer sheet can be immersed or otherwise contacted with the solution of second polymer at temperatures that are suitable to maintain the second polymer in solution prior to and during contact with first polymer sheet. It is preferred that it be accomplished at ambient temperatures. The microporous sheet is contacted with the second polymer for a time (normally about 1 to 60 seconds, preferably from 1 to 10 seconds and most preferably from about 1 to 5 seconds) to allow the solution to be distributed throughout the pore structure of the microporous first polymer sheet. Greater contact time may be used but is not normally required. This can be accomplished by passing the microporous first polymer sheet through a bath and at least one set of nip rollers. The treated sheet product is then washed with a low boiling solvent which is miscible with the liquid used to apply the second polymer but is a non-solvent with respect to the first and second polymers. Thus, the second polymer will deposit on the surfaces of the first polymer.

The second polymer need not cover all of the first polymer surfaces, but should cover at least about 50, preferably at least about 70 and more preferably at least about 90 percent of the surfaces. Further, the coating of second polymer should not be of a thickness that causes blockage of the pores of the microporous first polymer sheet. The resultant sheet product of the present invention will contain at least about 2 weight percent, such as 4 weight percent, preferably at least about 8 weight percent and most preferably at least about 10 weight percent of second polymer based on the total weight of the resultant sheet product. It is preferred that the second polymer be distributed in a substantially uniform manner throughout the first polymer surfaces.

In lieu of the high glass transition temperature, thermoplastic polymers described above, one can apply a thermoset polymer resin using conventional techniques known to those skilled in the art. For example, a prepolymer can be dissolved in a solvent along with the extender monomer and applied to the sheet of first polymer followed by heating of the coated sheet product to cause the formation of a thermoset polymer coating on the surface of the first polymer sheet. Alternately, a polymer having reactive sites can be dissolved in a solvent along with an agent capable of reacting with the polymer's reactive sites. The first polymer sheet is contacted with the formed solution, dried and heated to cause reaction of the cross-linking agent to provide a cross-linked thermoset polymer coated sheet product. The thermoset polymer should have a degradation temperature of at least 40 ° C. higher than the Tₘ of the first polymer forming the microporous sheet product. Again, the second polymer need not cover the entire surfaces of the first polymer, but should cover at least about 50, preferably at least about 70, more preferably at least about 80 and most preferably at least about 90 percent of the first polymer sheet surfaces. Sheet product having a thin coating of second polymer on at least about 70 percent of the first polymer surfaces exhibit exceptional dimensional stability.

It is believed, although not meant to be a limitation on the claimed invention appended hereto, that the second polymer forms a skeleton of sufficient structure to maintain separation of adjacent electrodes of opposite polarity in the battery. This feature is maintained even at temperatures under which the first polymer experiences dimensional instability, such as above the first polymer's T_{g}. The second polymer provides a degree of continuity, interlocking and integrity properties to the low glass transition polymer that causes a stable sheet product to be achieved. Further, the skeleton structure of the second polymer remains in place to maintain the electrodes apart at temperatures caused by abusive conditions. Thus, the first polymer may reach temperature that will allow it to melt to form a substantially non-porous mass while the second polymer maintains the electrode separation.

Illustrative examples of polymers useful as second polymers are given in Table 1 below:

TABLE 1

| | Tg (C.) | Tm (C.) | Solvent 1* | Solvent 2** |
|---|---|---|---|---|
| High Tg Thermoplastic Polymer | | | | |
| Polyvinyl chloride | 78 | 285 | ketones, esters | water |
| Polystyrene | 100 | 240 | Aromatics, Cl.H. | C₁-C₃ alcohol |
| Polymethyl methacrylate (syndiotatic) | 105 | 160 | ketones, aromatics, | C₁-C₃ alcohol, water |
| | | | Cl.H. | |
| Polytetraflouroethylene | 130 | 327 | water emulsion | |
| Polycarbonate | 150 | 267 | Aromatics, Cl.H. | C₁-C₃ alcohol, acetone, |
| | | | | air dry |
| Polysulfone | 190 | 343 | methylene chloride | C₁-C₃ alcohol, |
| Poly(diphenylether sulfone) | 230 | | | |
| Polyphenylene Sulfide | 85 | 288 | | |
| Polyphenylene Oxide | 180 | 285 | Aromatics, Cl.H. | C₁-C₃ alcohol |
| Polyvinyl acetate | 29 | | ketones, esters | water, air dry |
| Polyvinyl alcohol | 99 | 258 | C₁-C₅ Alcohols, | air dry |
| | | | water | |
| PETG (copolyester of ethylene | 81 | 232 | NMP³ | water |
| glycol/terephthalate) | | | | |
| Polyacrylonitrile | 104 | 317 | | |
| Methyl cellulose | 43 | 165 | Water | Air dry |
| Cellulose acetate | 157 | 306 | Ketones, esters, | C₁-C₃ alcohol |
| | | | Cl.H. | |
| Polyethylene terephthalate | 69 | 267 | NMP³ | water |
| Polyamide (polycaprolactam 6) | 50 | 225 | formic acid | water |
| Polyimide¹ | 250 to 365 | 388 | NMP³, aromatic | C₁-C₃ alcohol |
| Polyetherimide | 215 | | Aromatics, Cl.H, | C₁-C₃ alcohol, acetone, |
| | | | NMP³. | air dry |
| Liquid Crystal Polymer² | 310 | 340 | | |
| Thermoset Polymer Resin | | | | |
| Cellulose | | NA | CS₂, NaOH | sulfuric acid |
| Epoxy resin | | NA | Methanol, acetone | water |
| Polyester⁴ | | NA | acetone | water |
| Phenoxy resin | | NA | | |
| Urea formaldehyde | | NA | | |
| Phenol formaldehyde | | NA | | |
| Polyurethane | | NA | | |

*Example of liquids for which indicated second polymer is soluble.
**Example of liquids and/or conditions for which indicated second polymer is immiscible and may be used to remove solvent 1 from sheet product.
¹Polyimide refers to polymer formed by the condensation reactions of dicarboxylic acids or dianhydrides with diamines
²Liquid Crystal Polymer refers to polymers based on the polymerization of p-hydroxybenzoic acid monomer groups exhibiting partially crystalline structure (as oppose to amorphous) in the melt phase.
³NMP refers to 1-methyl-2-pyrrolidinone
⁴Polyester refers to a polymerization product of diglycols with dicarboxylic acids followed by addition of anhydrides and styrene, the reaction initiated with peroxides.

The second polymer forming the coating of the present sheet product should be selected from thermoplastic polymers (preferred) having a glass transition temperature, T_{g}, of at least 60° C., preferably at least about 80° C. and most preferably at least about 110° C. higher than that of the selected first polymer or a thermoset polymer having a degradation temperature of at least 40° C. higher than the Tₘ of the selected first polymer. The second polymer should be contacted with the microporous sheet of first polymer composition so that the resultant microporous sheet product comprises at least about 2 weight percent, such as 4 weight percent, preferably at least about 8 weight percent and most preferably at least 10 weight percent of the resultant formed microporous sheet product of the present invention. Further, the formed microporous sheet product should have a pore volume (as measured in accordance with the procedure described in the examples given herein below) of at least about 15 percent, preferably at least about 25 percent of the resultant sheet product.

The sheet product of the present invention can be used as a separator in battery formations. The present sheet product may be the sole sheet product forming the battery separator or, alternately, the present sheet product may be used in combination with other sheet materials to provide an improved multi-ply sheet material useful as a battery separator. The other plies of the resultant separator can be selected, for example, form conventional sheets used as battery separators, such as microporous polyethylene, microporous polypropylene and the like which are filled or unfilled as well as woven or non-woven fibrous sheets. The sheet product of the present invention may form the external or an internal ply of a multi-ply sheet.

The following examples are given as specific illustrations of the present invention. It should be understood, however, that the invention is not limited to the specific details set forth in the examples. All parts and percentages in the examples, as well as in the remainder of the specification, are by weight unless otherwise specified.

Further, any range of numbers recited in the specification or claims, such as representing a particular set of properties, units of measure, conditions, physical states or percentages, is intended to literally incorporate expressly herein by reference or otherwise, any number falling within such range, including any subset of numbers within any range so recited.

### EXAMPLES

### The Commercially Obtained Materials Used in the Examples Herein Below are:

Polyethylene (LM600700) from Equistar.
Polyester (unsaturated polyester resin cross-linked with styrene monomer and MEKP as initiator) from Bondo Corporation.
Polysulfone (P3500) from Amoco Performance Products Inc.
Polysulfone (Udel P-1700) from Solvay Chemicals
Poly(methylmethacrylate) from Aldrich Chemical Co.
Epoxy resin (polymercaptan and amine) from Henkel Consumer Adhesive Inc.
PETG (polyethylene terephthalate glycol copolymer 6763) from Eastman Chemical Co.
Microporous sheet separator products of:
   Polyethylene separator (N 9620) from Asahi Chemical Co.
   Polypropylene separator (K256) from Celgard Inc.
   Polyethylene microporous sheets formed by APorous, Inc
Dichloromethane from Aldrich Chemical Co., USA.
Methyl ethyl ketone from Aldrich Chemical Co., USA.
Isopropyl alcohol from Aldrich Chemical Co., USA.

### The Following Equipment Was Used in the Examples Herein Below:

Electric mixer, Model RZR2000, made by Caframo Co., Canada.
Electric magnetic mixer, Model Cimarec 3, made by Thermolyne Co., USA.
Polymer coating tank, 9×9×5 inches (L×W×H) with 3 compartments and web transfer rollers within.

### The Following Processing Methods Were Used:

A specific amount of high T_{g} second polymer was dissolved in one liter of solvent 1 indicated herein below to provide a specified concentration of the target coating solution. The solvent was agitated for at least one hour while the polymer was allowed to dissolve. The resultant solution was poured into the Tank 1 of the coating apparatus. Tank 2 was filled with Solvent 2 while Tank 3 was filled with distilled water.

A preformed microporous sheet of first polymer was sequentially pulled through the compartments #1, #2, and then #3 of the second polymer coating apparatus. Tank #1 added on the high T_{g} second polymer solution. Tank #2 coagulated the high T_{g} polymer solution while removing the solvent of tank #1. Tank #3 removed the solvent of Tank #2.

The resultant sheet product separator was then dried over steam cans at 200° F. (93° C.), with residence time of one minute.
The sheet product separator was than subjected to heated cans at 220° F. (104° C.), with residence time of two minutes followed by rewinding for subsequent testing.

### The Following Test Methods Were Used:

Moisture Vapor Transmission Rate (“MVTR”): according to ASTM E-96 Method E.
Tensile Strength according to ASTM D5034-95.
   Porosity or Pore Volume Test was conducted as follows:

The pore volume was calculated from the difference between the separator volume and the volume of solid from which the separator was made. The following test procedure was used:

A template measuring 2″×2″ was placed on the separator. A sharp blade was used to cut around the template to make a sample measuring 2″×2″. A Mitutoyo Thickness Gauge, model ID-C 112TB, was used to measure the thickness of the separator. The separator was weighed to determine the Dry-Weight (in grams) of the separator. The separator was then immersed in isopropyl alcohol, then water and removed after 30 minutes. It was allowed to drip dry for 30 seconds to remove any excess surface water. The separator was reweighed to determine the Wet-Weight of the separator. The pore volume of the separator was calculated by subtracting the Dry-Weight from the Wet-Weight, in grams. The difference was converted into cubic centimeter by knowing the specific gravity of the water as being one gram per cubic centimeter. The total volume of the separator was calculated by multiplying the surface area of the separator by the thickness. The porosity was calculated by dividing the pore volume by the total volume.

Electrical Resistance test procedure was conducted according to ASTM D202-97 wherein the separator sample was placed between a frame having a square opening measuring one centimeter by one centimeter. The separator and frame were pre-soaked in isopropanol for one minute followed by immersion in 30% KOH electrolyte for 5 minutes. The separator and frame were placed in an electrolytic cell followed by measuring the resistance via a Hewlett Packard 4338B Milliohmmeter, in milliohms. The separator was removed from the frame and again measured the resistance via the Milliohmmeter. The difference of the two readings provided the separator resistance, or RA, in units of milliohm-cm-square.

The following equation applies:

RA=rl

wherein
R=electrical resistance in ohms; A=test area in centimeter square; r=resistivity in ohm-cm; and 1=thickness of the separator in centimeters.

### Example 1

A microporous polyethylene sheet was formed by extruding a composition of polyethylene (Equistar ML 600700) with 60 wt. percent light petroleum oil through a slit die followed by contacting the initial sheet with toluene to remove the oil. The sheet was then stretched in the transverse direction via a Marshall and Williams tenter frame at 93° C. (200° F.), subsequently in the axial direction with a pair of nip rollers (Davis Standard haul-off) at 104° C. (220° F.) to form a microporous sheet product having gas porosity of 80%, a basis weight of 6 gm/m² and a thickness of 32 microns. This sheet was then treated by contacting with a solution having 7% polysulfone (P3500) from Amoco Performance Products Inc. in dichloromethane for about 5 to 10 seconds. The solution treated product was then washed in isopropyl alcohol, dried and annealed at 93° C. (200° F.) to provide a microporous sheet product according to the present invention. In Table 2 below, the formed separator according to the present invention (Sample I) was compared to the untreated (non-coated) microporous sheet (Sample C-I). In Table 3 below, a commercial microporous sheet separators (microporous polypropylene separator sheet product sold by Celgard as product K256) was treated with the polysulfone in the same manner as described above for Sample I to form a coated product (Sample II) and compared to the untreated commercial product (Sample C-II). In Table 4 below, a microporous polyethylene sheet product sold by Asahi as product (N9620) was treated with the polysulfone in the same manner as described above for Sample I to form a coated product (Sample III) and compared to untreated commercial product of Asahi (Sample C-III).

The comparative data of Tables 2, 3 and 4 each illustrate the improvement in dimensional stability achieved by the coated samples according to the present invention over that of microporous sheet products of various first polymers without a second polymer coating thereon. Further, each of the coated microporous sheet products showed low resistivity of the original formed product while exhibiting high ionic resistivity when subjected to elevated temperatures. The sheet products were heated from ambient temperature to the indicated elevated temperature at a rate of about 25° C. per minute. Such resistivity profile would provide a desirable separator product at normal operating temperatures while causing a shut-down of a battery formed using the coated separator sheet product at elevated temperature conditions.

TABLE 2

| | Sample | |
|---|---|---|
| | I | C-I |
| Open Porosity (vol. %) | 57% | 80% |
| Basis Wt. (gm/m. sq.) | 14.7 | 6.0 |
| Initial Length (cm) | 10.0 | 10.0 |
| Initial Width (cm) | 5.5 | 5.5 |
| Final Length (cm at 150 C.) | 9.6 | 7.3 |
| Final Width (cm at 150 C.) | 5.3 | 4.5 |
| Length Shrinkage (% at 150 C.) | −4% | −27% |
| Width Shrinkage (% at 150 C.) | −4% | −18% |
| Original ionic resistance (mohm- | 58 | 26 |
| cm. sq.) | | |
| Heat-treated ionic resistance (at | 2257 | NA (melted) |
| 150 C., mohm-cm. sq.) | | |
| Appearance at 100 C. | No visual change | film wrinkled |
| | | from shrinkage |
| Appearance at 150 C. | No visual change | film melted, color |
| | | turned clear from |
| | | white |

TABLE 3

| | Sample | |
|---|---|---|
| | II | C-II |
| Open Porosity (vol. %) | 34% | 32% |
| Basis Wt. (gm/m. sq.) | 25.9 | 23.9 |
| Initial Length (cm) | 10.0 | 10.0 |
| Initial Width (cm) | 2.7 | 2.7 |
| Final Length (cm at 150 C.) | 8.5 | 5.2 |
| Final Width (cm at 150 C.) | 2.6 | 2.8 |
| Length Shrinkage (% at 150 C.) | −15% | −48% |
| Width Shrinkage (% at 150 C.) | −4% | +4% |
| Original ionic resistance (mohm- | 461 | 50 |
| cm. sq.) | | |
| Heat-treated ionic resistance (at | 13200 | NA (melted) |
| 200 C, mohm-cm. sq.) | | |
| Appearance at 100 C. | No visual change | film wrinkled from |
| | | shrinkage |
| Appearance at 150 C. | Slightly wrinkled | film melted, color |
| | in spots | turned clear |
| | | from white |

TABLE 4

| | Sample | |
|---|---|---|
| | III | C-III |
| Open Porosity (vol. %) | 27% | 35% |
| Basis Wt. (gm/m. sq.) | 15.8 | 13.1 |
| Initial Length (cm) | 10.0 | 10.0 |
| Initial Width (cm) | 3.1 | 6.0 |
| Final Length (cm at 150 C.) | 9.2 | 6.8 |
| Final Width (cm at 150 C.) | 3.1 | 3.1 |
| Length Shrinkage (% at 150 C.) | −8% | −32% |
| Width Shrinkage (% at 150 C.) | 0% | −48% |
| Original ionic resistance (mohm- | 883 | 25 |
| cm. sq.) | | |
| Heat-treated ionic resistance (at | 31700 | NA (melted) |
| 200 C., mohm-cm. sq.) | | |
| Appearance at 100 C. | No visual change | film wrinkled from |
| | | shrinkage |
| Appearance at 150 C. | Slightly wrinkled | film melted, color |
| | in spots | turned clear |
| | | from white |

Examples 2-5 herein below used the following polymers and solvents for forming the microporous sheet products according to the present invention. The APorous microporous sheet product used as the first sheet was formed in the same manner as described in Example 1 above.

| | Tg | Tm | Solvent | Coagulants |
|---|---|---|---|---|
| Second High Tg | | | | |
| Thermoplastic Polymer | | | | |
| PETG | 81 | 232 | NMP | ethanol, water |
| Polymethyl methacrylate | 105 | 160 | NMP | ethanol, water |
| Polycarbonate | 150 | 267 | methylene | ethanol, air dry |
| | | | chloride | |
| Polysulfone | 190 | 343 | methylene | ethanol, air dry |
| | | | chloride | |
| Second Thermoset Resin | | | | |
| Epoxy resin | | NA | acetone | Water |
| Polyester | | NA | acetone | Water |

| | Source |
|---|---|
| Material | |
| PETG | Eastmen Chemical Polyester 6763 |
| Polymethyl methacrylate | Aldrich Chemical Co., |
| Polycarbonate | Bayer, Makrolan 1239 |
| Polysulfone | Solvay, Udel P-1700 |
| Epoxy resin | Henkel Consumer Adhesive Inc. |
| (polymercaptan and amine) | |
| Polyester | Bondo Corp. |
| First Polymer Sheet | |
| Product | |
| Microporous polyethylene | Asahi Chemical Co., grade N9620 |
| battery separator “ABS” | |
| Microporous polypropylene | Celgard Inc., grade K256 |
| battery separator “CBS” | |
| Microporous polyethylene | APorous Inc., polyethylene separator, |
| battery separator “APBS” | formed using polyethylene (LM600700) |
| | from Equistar. Post axial stretched by |
| | additional 2X after the described |
| | formation steps. Porosity of 82%, dry |
| | basis weight of 4.8 g/m² and |
| | thickness of 24 microns |

### Material Testing Methods:

The dry Basis Weight and the Second polymer percentages were calculated based on the “weight per area” measurement. The following test procedures were used:

A template measuring 2″×2″ was placed on the separator. A sharp blade was used to cut around the template to make a sample measuring 2″×2″. The separator was weighed on a balance (Ohaus model: TS200S). The weight of the separator was recorded in grams.

### Basis Weight

Basis weight of the separator was calculated as the separator weight divided by the 2 by 2 inches area. The area was converted into meter square. The conversion factor is 1 inch equals 0.0254 meter. The basis weight data was recorded in grams per meter square.

### Second Polymer Percentage

The second polymer percentage data is measured by the same method as the basis weight calculation. The second polymer impregnated separator is dried for 30 minutes at 70° C. prior to testing. The second polymer percentage is calculated as the second polymer separator basis weight minus the base separator basis weight (prior to the second polymer impregnation), divided by the second polymer separator basis weight. The ratio is converted into percentage.

### Shrinkage Test

The shrinkage percentage was recorded as the separator dimensional reduction from the original separator dimension due to heat exposure. The test separator was cut to 10 centimeter in length (machine direction, MD) by 6 centimeter in width (transverse or cross machine direction, TD). This was the original dimension prior to heat test. The separator was exposed to a target temperature for a specific duration in a laboratory oven. The dimension of the separator was re-measured after the temperature test, the resulted dimension recorded. The MD and TD shrinkage was calculated as the original dimension minus the new dimension divided by the original dimension. This ratio is converted into percentage.

The separator was taped onto an aluminum support plate measuring 6 by 12 inches during the test. When the separator was tested taped on one of the machine direction edge, the separator was allowed to shrink in both the MD and TD dimensions. When the separator was tested taped on both of the MD dimension edges, the separator was only allowed to shrink in the TD width dimension.

### Example 2

Sheet products were formed using APBS sheet product which was treated with second polymer solutions and than coagulant solvent indicated above to form coated product according to the present invention. Each of the coated products exhibited very low shrinkage properties while having low resistivity at ambient temperatures and high resistivity at elevated temperatures to shut down an errand battery system. The data is reported in Tables 2A and 2B below.

TABLE 2A
Physical data of APorous Separator D10 mk3 Impregnated with Second High Tg Polymer

| | | | | | | Resistivity |
|---|---|---|---|---|---|---|
| | | Dry Basis | | Second | Resistivity | after 150 C. |
| | | Weight | | High Tg | before Test | Heat Test |
| Sample ID | Solution | g/m-sq | Porosity % | Poly % | (ohm-cm.) | (ohm-cm.) |
| APBS (control) | none | 4.8 | 82% | 0% | 23 | 25851 |
| APBS/S3 | polysulfone at 3% polymer | 7.6 | 73% | 37% | 8 | 18700 |
| APBS/S5 | polysulfone at 5% polymer | 7.5 | 73% | 35% | 17 | 15010 |
| APBS/T8 | PETG at 8% polymer | 6.0 | 80% | 20% | 40 | 21232 |

TABLE 2B
MD Shrinkage Test at 150 C. for 5 minutes

| | MD | |
|---|---|---|
| | Shrinkage | Appearance |
| APBS | −82% | @117 C. buckle, @133 C. melted and shrunk |
| (control) | | |
| APBS/S3 | −37% | @120 C., started buckling, melted at 137 C. |
| APBS/S5 | −13% | @125 C. buckle, color opaque after melt |
| APBS/T8 | −22% | @117 C. buckle, color opaque after melt |

*All tests conducted with separators taped on one-end to allow lengthwise shrinkage, unless otherwise specified.

### Example 3

The procedure described in Example 2 above was repeated except that commercial ABS and CBS separator sheet products were used as first polymer. The test results are given in Tables 3A and 3B below.

TABLE 3A
Comparative Physical data of uncoated ABS and CSB Separators
versus Coated with Second Polymer

| | | Dry | | | Resistivity |
|---|---|---|---|---|---|
| | | Basis | | Second | before |
| | | Weight | Porosity | High Tg | Test |
| Sample ID | Solution | g/m-sq | % | Poly % | (ohm-cm.) |
| ABS(control) | none | 11.7 | 36% | 0% | 14 |
| ABS/S12 | polysulfone at | 15.7 | 28% | 25% | 113 |
| | 12% polymer | | | | |
| CBS (control) | none | 22.3 | 34% | 0% | 16 |
| CBS/S12 | polysulfone at | 25.4 | 19% | 12% | 68 |
| | 12% polymer | | | | |

TABLE 3B
Comparative MD and TD Shrinkage Test at 100 C. for one hour

| | Shrinkage MD** | Shrinkage TD* |
|---|---|---|
| ABS (control) | −9% | −41% |
| ABS/S12 | −3% | −19% |
| CBS (control) | −45% | 0% |
| CBS/S12 | −6% | 0% |

*TD is designated as transverse or width direction of separator from manufacturing
**MD is designated as machine or length direction of the separator from manufacturing

### Example 4

The procedure described in Example 3 above was repeated except that a polyester or an epoxy thermoset resin was used as the second polymer. The test results are given in Tables 4A and 4B below.

TABLE 4A
Physical Properties of ABS Separator Impregnated with Thermoset Resins

| | | | Dry Basis | | | Resistivity |
|---|---|---|---|---|---|---|
| | | Thickness | Weight | | High Tg | before Test |
| Sample ID | Solution | (micron) | g/m-sq | Porosity % | Poly % | (ohm-cm.) |
| ABS (control) | none | 19 | 11.4 | 41% | 0% | 36 |
| ABS/Epoxy | Epoxy at 12% polymer | 20 | 12.9 | 21% | 13% | 44 |
| ABS/Polyester | Polyester at 12% polymer | 20 | 12.4 | 37% | 9% | 27 |

TABLE 4B
Shrinkage Tested (heated for 5 minutes)

| Test Temperature | 120 C. |
|---|---|
| Direction of Shrinkage | MD |
| ABS (control) | −21% |
| ABS/Epoxy | −3% |
| ABS/Polyester | −5% |

### Example 5

The procedure described in Example 2 above was repeated except that commercially obtained second polymers indicated below were used in varying concentrations to form the coated sheet product. The test results are given in Tables 5A, 5B and 5C below.

TABLE 5A
Physical Properties of ABS Separator Impregnated with Second High Tg Polymer

| | | | Dry | | | | Resistivity | Resistivity |
|---|---|---|---|---|---|---|---|---|
| | | | Basis | | Second | Resistivity | after 120 C. | after 150 C. |
| | | Thickness | Weight | | High Tg | before Test | Heat Test | Heat Test |
| Sample ID | Solution | (micron) | g/m-sq | Porosity | Poly % | (ohm-cm.) | (ohm-cm.) | (ohm-cm.) |
| ABS | none | 20 | 10.8 | 42% | 0% | 19 | 55 | 27487 |
| (control) | | | | | | | | |
| ABS/C1 | polycarbonate at 1% polymer | 18 | 11.9 | 40% | 6% | 41 | 44 | |
| ABS/S1 | polysulfone at 1% polymer | 20 | 11.7 | 39% | 4% | 28 | 68 | |
| ABS/C3 | polycarbonate at 3% polymer | 21 | 12.4 | 38% | 10% | 19 | 56 | 30475 |
| ABS/S3 | polysulfone at 3% polymer | 21 | 12.4 | 38% | 10% | 38 | 35 | 26403 |
| ABS/S5 | polysulfone at 5% polymer | 20 | 12.4 | 33% | 13% | 46 | 92 | 31678 |
| ABS/C8 | polycarbonate at 8% polymer | 21 | 14.3 | 29% | 22% | 20 | 342 | 687 |
| ABS/S8 | polysulfone at 8% polymer | 20 | 14.1 | 36% | 20% | 17 | 41 | 28503 |
| ABS/S8 | polysulfone at 8% polymer | 19 | 13.2 | 30% | 18% | 72 | 163 | 27539 |
| ABS/S8 | polysulfone at 8% polymer | 20 | 13.6 | 33% | 17% | 76 | 69 | 31119 |
| ABS/T8 | PETG at 8% polymer | 18 | 12.2 | 48% | 8% | 55 | 125 | |
| ABS/T12 | PETG at 12% polymer | 30 | 13.5 | 23% | 19% | 37 | 169 | 19616 |
| ABS/T12 | PETG at 12% polymer | 48 | 20.3 | 37% | 45% | 63 | 6976 | 7193 |
| ABS/M12 | polymethyl methacrylate at | 20 | 13.4 | 37% | 19% | 67 | | |
| | 12% polymer | | | | | | | |

TABLE 5B
Separator Shrinkage Tests at 120 C. for 5 minutes

| | MD Shrinkage |
|---|---|
| ABS/(control) | −43% |
| ABS/C1 | −22% |
| ABS/S1 | −1% |
| ABS/C3 | −6% |
| ABS/S3 | −7% |
| ABS/S5 | −11% |
| ABS/T8 | −6% |
| ABS/C8 | −7% |
| ABS/S8 | −7% |
| ABS/T12 | −6% |
| ABS/T12 | −4% |
| ABS/M12 | −10% |

TABLE 5C
Separator Shrinkage Tests Taped on Both Ends at 200 C. for 5 minutes

| | MD | TD | Appearance |
|---|---|---|---|
| ABS (control) | −95% | −100% | Broke, torn in half from heat shrinkage |
| ABS/C1 | −95% | −100% | Broke, torn in half from heat shrinkage |
| ABS/S1 | 0% | −27% | Contiguous with few pin holes |
| ABS/C3 | 0% | −61% | |
| ABS/S3 | 0% | −27% | |
| ABS/S5 | 0% | −16% | |
| ABS/C8 | 0% | −20% | |
| ABS/S8 | 0% | −42% | Contiguous with few pin-holes |
| ABS/S12 | 0% | −14% | |

The above sheet products were taped down on both ends to demonstrate width shrinkage from heat. This simulated wound prismatic cell, where two ends of separator are pinned-down by the wrapping of, and between the electrodes.

### Example 6

Two electrolytic cells were formed, each comprising a lithium cobalt oxide positive electrode, a carbon negative electrode, a separator composed of a microporous polyethylene sheet product and ethylene carbonate/dimethyl carbonate/1 molar LiPF₆ salt, as the electrolyte.

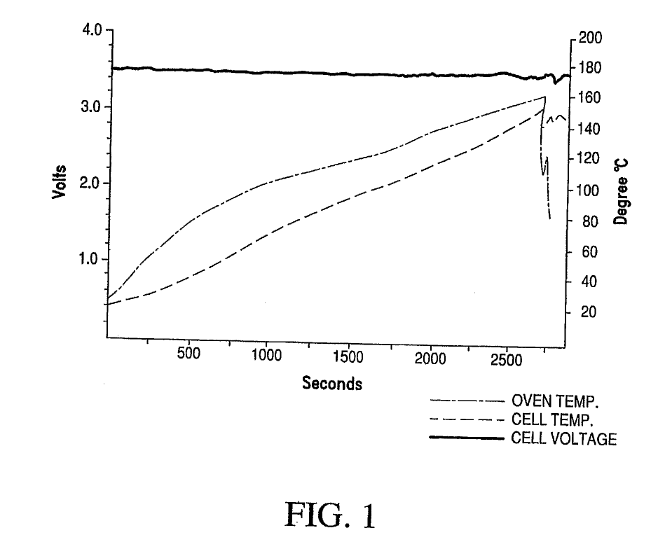

One cell used an ABS/S8 microporous sheet product formed as described above as the separator. The cell was connected to a thermocouple to measure the cell temperature and to a voltmeter to measure the voltage across the cell. The cell was placed in an oven which was slowly heated over time. The internal temperature of the oven (1), the temperature of the cell (2) and the cell voltage (3) were recorded. The test results are shown in FIG. 1. The cell voltage showed a continuous functioning of the cell over the oven temperature range of from ambient to 160° C. Further, the cell did not encounter an extended temperature that exceeded the oven temperature showing that the cell did not experience a thermal run away condition.

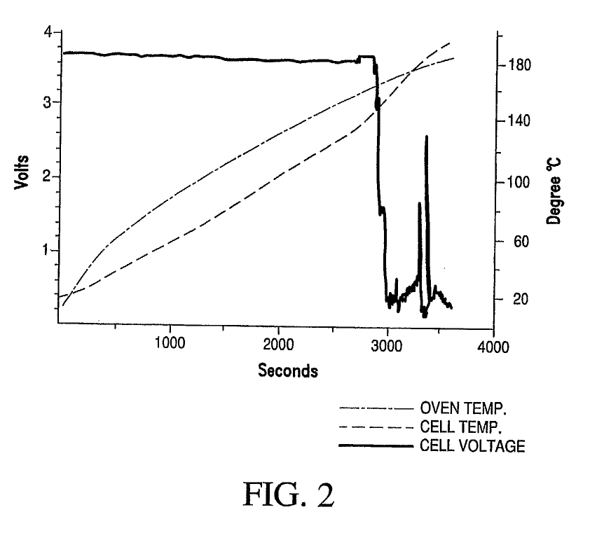

A second cell was formed for comparative purposes which used a commercial microporous polyethylene separator sheet product sold by Asahi (“ABS”). The cell was connected to a thermocouple to measure the cell temperature and to a voltmeter to measure the voltage across the cell. The cell was placed in an oven which was slowly heated over time. The internal temperature of the oven (1), the temperature of the cell (2) and the cell voltage (3) were recorded. The test results are shown in FIG. 2. The cell voltage showed a shutdown of the cell due to shorting at the cell temperature of 135° C. Further, the cell had an extended temperature that exceeded the oven temperature showing that the cell experienced thermal run away caused by shorting of the electrodes due to the breakdown of the separator membrane.

I claim:

1. A battery separator composed of a microporous sheet product having at least one ply, wherein at least one of said ply comprises a microporous sheet comprising a polymeric composition of first polymer and having a second polymer coating a major portion of the pore and external surfaces of said first polymer microporous sheet, said first polymer being selected from a thermoplastic polymer inert to battery environs and having a T_{g} of less than −5° C. and a Tₘ of at least 70° C. and said second polymer being selected from (a) a thermoplastic polymer inert to battery environs and having a T_{g} at least 60° C. higher than said first polymer T_{g}or (b) a thermoset polymer having a degradation temperature at least 40° C. higher than the Tₘ of said first polymer.

2. The battery separator of claim 1 wherein said first polymer is selected from polyethylene, polypropylene, copolymers thereof and mixtures thereof and said second polymer covers at least 50 percent of the pore surface and external surface of the first polymer microporous sheet.

3. The separator of claim 1 wherein the first polymer has a T_{g} of less than −20° C. and a Tₘ of at least 90° C.

4. The separator of claim 2 wherein said first polymer comprises a copolymer of ethylene or propylene with a monomer of a C₄-C₁₀ alpha olefin, and said alpha olefin monomer units are present in from 5 to 20 weight percent of said first polymer.

5. The separator of claim 1, 2, 3, or 4 wherein the second polymer covers at least 70 percent of the pore and external surfaces of the microporous sheet of first polymer composition.

6. The separator of claim 1, 2, 3 or 4 wherein the second polymer is a thermoplastic polymer selected from the group consisting essentially of polyvinyl chloride, polystyrene, polymethylmethacrylate, polytetraflouroethylene, polycarbonate, polysulfone, polyphenylene sulfide, polyphenylene oxide, polyvinyl acetate, polyvinyl alcohol, polyacrylonitrile, methylcellulose, cellulose acetate, polyethyleneterephthalate, polyamides or polyimides or mixtures thereof.

7. The separator of claim 6 wherein the second polymer is selected from a polysulfone.

8. The separator of claim 1, 2, 3 or 4 wherein the second polymer is a thermoset polymer selected from epoxy resin, phenoxy resin, urea-formaldehyde resin, phenol-formaldehyde resin, polyurethanes or mixtures thereof.

9. The separator of claim 8 wherein the second polymer is selected from urea-formaldehyde resin, phenol-formaldehyde resin, epoxy resins or mixtures thereof.

10. The separator of claim 5 wherein the second polymer comprises a thermoplastic having a T_{g} at least 110° C. above that of the first polymer and the first polymer is selected from polyethylene or polypropylene or copolymers thereof.

11. The separator of claim 8 wherein the second polymer comprises a thermoplastic having a T_{g} at least 110° C. above that of the first polymer and the first polymer is selected from polyethylene or polypropylene or copolymers thereof.

12. The separator of claim 5 wherein the microporous sheet product is composed of at least 2 weight percent of second polymer.

13. The separator of claim 7 wherein the microporous sheet product is composed of at least 2 weight percent of second polymer.

14. The separator of claim 8 wherein the microporous sheet product is composed of at least 2 weight percent of second polymer.

15. The separator of claim 5 wherein the microporous sheet product is composed of at least 10 weight percent of second polymer.

16. The separator of claim 7 wherein the microporous sheet product is composed of at least 10 weight percent of second polymer.

17. The separator of claim 8 wherein the microporous sheet product is composed of at least 10 weight percent of second polymer.

18. The separator of claim 5 wherein the second polymer is selected from a thermoplastic polymer having a T_{g} of at least 80° C. above the T_{g} of the first polymer.

19. The separator of claim 7 wherein the second polymer is selected from a thermoplastic polymer having a T_{g} of at least 80° C. above the T_{g} of the first polymer.
